(19) United States
(12) Patent Application Publication
(10) Pub. No.: US 2009/0206534 A1
(43) Pub. Date: Aug. 20, 2009

(54) CamLock Clamp

(76) Inventor: Robert E. McCracken, Anderson, SC (US)

Correspondence Address: MICHAEL, BEST & FRIEDRICH LLP, 100 EAST WISCONSIN AVENUE, SUITE 3300, MILWAUKEE, WI, 53202, US

(21) Appl. No.: 12/031,210

(22) Filed: Feb. 14, 2008

(51) Int. Cl. B25B 5/02; B25B 5/08; B25B 5/16

(52) U.S. Cl. 269/6; 269/90; 269/229; 269/136

(57) ABSTRACT

A cam actuated quick action clamp used to clamp or separate two or more workpieces. The quick action clamp has a lever with an eccentric portion disposed above a bar. The eccentric portion of the lever is fixedly coupled with a jamb plate to produce a force along the clamping face of a housing in order to maximize the clamping force exerted on the workpiece or workpieces.

### BACKGROUND

The present invention relates to a clamp, and more specifically, a cam actuated quick action clamp.

Most quick action clamps that are produced today achieve forward motion through a jamb plate that is directly coupled to a lever. The jamb plate binds against a rod, which allows the clamp to travel along the bar towards, or away from, a second jaw. The force, therefore, is an axial force along the bar, which is produced by the pivoting of the lever. However, not all of the force produced by the actuation of the jamb plate and lever is transferred to the jaw portion of the clamp because this force is vertically offset from the location of the jaw, and where the clamping force is actually required. The offset, in addition, can cause the quick action clamp to unexpectedly pivot or rotate.

### SUMMARY

According to one embodiment of the present invention, the quick action clamp comprises a housing having a front portion and a rear portion, a first jaw coupled to the front portion of the housing, a bar, having a first end and a second end, where the housing is movably disposed on a portion of the bar, where a second jaw is coupled to one end of the bar, and a handle portion that forms part of the rear portion of the housing, where the housing also has a lever mounted within, and extending from, the housing where the lever has an eccentric portion that is disposed above the bar, where a first jamb plate is fixedly coupled with the eccentric portion of the lever, and where the bar is disposed through the first jamb plate.

According to another embodiment of the present invention, the quick action clamp comprises a housing having a front portion and a rear portion with a first jaw coupled to the rear portion, where a bar, having a first end and a second end, is disposed within the housing, such that the housing is movably disposed on a portion of the bar, and where the housing can move in a first direction or a second direction with respect to the bar. A second jaw is coupled to one end of the bar, where as the housing moves in the first direction, the first jaw converges towards the second jaw, and as the housing moves in the second direction, the first jaw diverges from the second jaw. A handle is also coupled with the rear portion of the housing, and a lever that is pivotally mounted to, and extending from, the housing has a lever non-actuated position and a lever actuated position, where the lever has an eccentric portion disposed in the housing above the bar. A first jamb plate is also coupled with the eccentric portion of the lever and has a first jamb plate engaging position and a first jamb plate non-engaging position, and a second jamb plate is also disposed in the housing, where the bar is disposed through the first jamb plate and the second jamb plate, wherein the second jamb plate has a second jamb plate non-release position and a second jamb plate release position. When the lever is in the non-actuating position, the first jamb plate is in the first jamb plate non-engaging position and the second jamb plate is in the second jamb plate non-release position, and when the lever is actuated towards the lever actuating position, the first jamb plate is in the first jamb plate engaging position and displaces the housing in a first direction, and the second jamb plate is still in the non-release position, which prevents the housing to move in a direction opposite from the first direction.

According to yet another embodiment of the present invention, a quick action clamp comprises a housing having a front portion and a rear portion, a bar, having a first end and a second end, where the housing is movably disposed on a portion of the bar, and where the housing can move in a first direction or a second direction with respect to the bar. A handle portion forms part of the rear portion of the housing, and has a lever disposed within, and extending from, the housing having a lever actuating position and a lever non-actuating position, where the lever has an eccentric portion disposed above the bar. A first jamb plate is fixedly coupled with the eccentric portion of the lever having a first jamb plate engaging position, where the first jamb plate is fixedly engaged with the bar in the first direction, and a first jamb plate non-engaging position, where the first jamb plate is disengaged from the bar in the first direction. A second jamb plate is also disposed within the housing and has a second jamb plate non-release position, where the second jamb plate is not fixedly engaged with the bar in the first or second direction. A jamb plate release actuator is slidingly disposed in the housing and has a release position and a non-release position, and comprises a first upward projection adjacent to the first jamb plate, and a second upward projection adjacent to the second jamb plate, such that when the jamb plate release actuator is in the non-release position, the first projection is adjacent to the jamb plate, and when in the release position, the second projection positions the second jamb plate in the second jamb plate release position.

### BRIEF DESCRIPTION OF THE DRAWINGS

FIG. 1 is a perspective view of one embodiment of a portion of the clamp according to the present invention where the clamp is a cam actuated quick action clamp.

FIG. 2 is a perspective view of certain structural features of the clamp shown in FIG. 1.

FIG. 3 is a perspective view of certain structural features of the clamp shown in FIG. 1.

FIG. 4 is a perspective view of certain structural features of the clamp shown in FIG. 1.

FIG. 5 is a perspective view of the detent member of the quick action clamp of FIG. 1.

FIG. 6 is a perspective view of the lever of the cam actuated quick action clamp of FIG. 1.

FIG. 7 is a perspective view of another embodiment of a portion of the clamp according to the present invention where the clamp is a cam actuated quick action clamp.

FIG. 8 is an exploded view of a portion of the clamp according to the present invention where the clamp is a cam actuated quick action clamp of FIG. 1.

FIG. 9 is another exploded view of a portion of the clamp according to the present invention where the clamp is a cam actuated quick action clamp of FIG. 1.

FIG. 10 is a perspective view of the first jamb plate of the clamp according to the present invention where the clamp is a cam actuated quick action clamp of FIG. 1.

FIG. 11 is a perspective view of the second jamb plate of the clamp according to the present invention, where the clamp is a cam actuated quick action clamp of FIG. 1.

### DETAILED DESCRIPTION OF EMBODIMENTS

The invention is described with reference to the drawings in which like elements are referred to by like numerals. The relationship and function of the various elements of this invention are better understood by the following description. Each aspect so defined may be combined with any other aspect or aspects unless clearly indicated to the contrary. The embodiments described below are by way of example only, and the invention is not limited to the embodiments illustrated in the drawings.

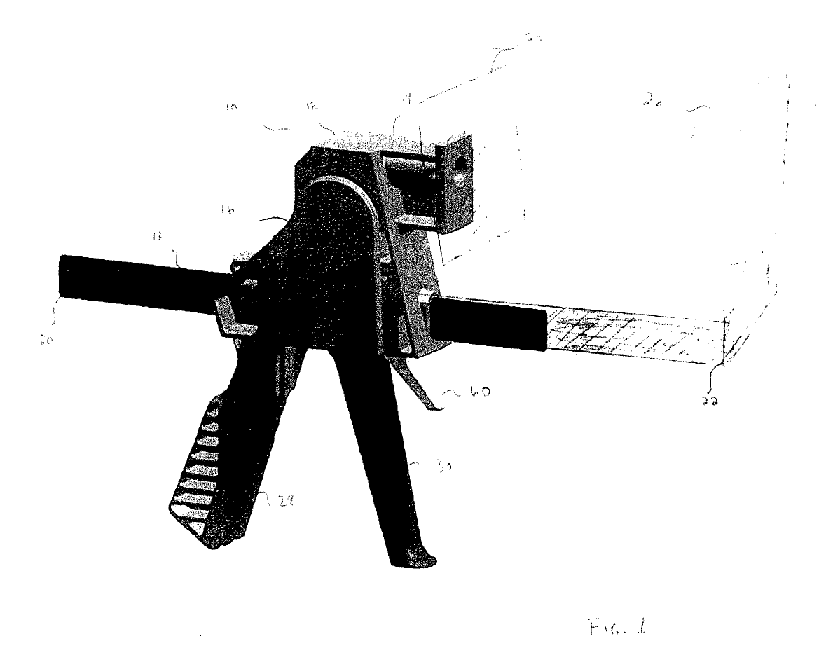

Turning now to the drawings and referring to FIG. 1, a clamp 10 is shown. For ease of reference and description, the inventive concepts are shown as configured with a cam actuated quick action clamp. It is to be understood, however, that the principles of the present invention can be applied to a variety of clamping mechanisms, and therefore, the invention is not so limited.

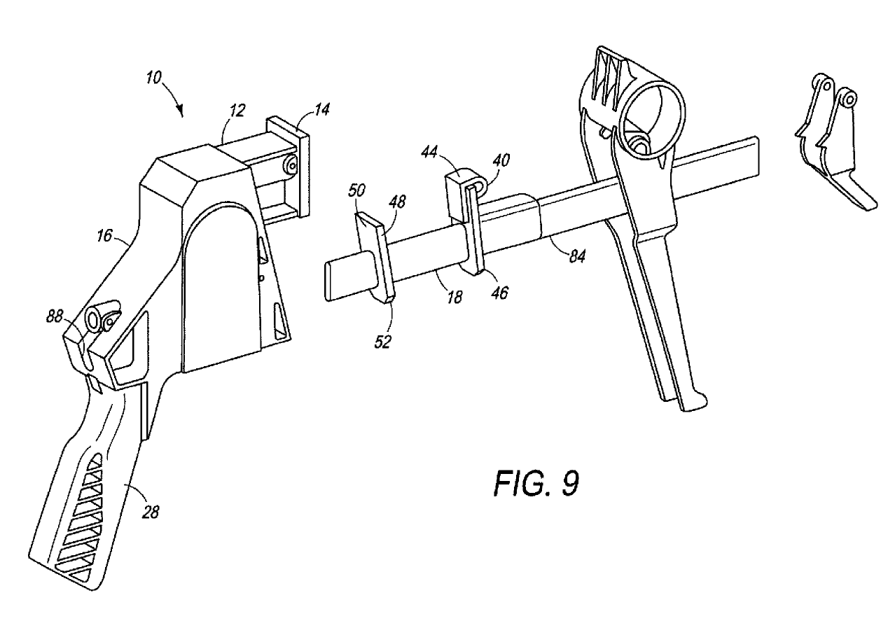

The cam actuated quick action clamp 10 has a housing 12, having a front portion 14 and a rear portion 16, and a bar 18, having a first end 20 and a second end 22, where the bar 18 is slidingly disposed through a portion of the housing 12. The bar 18 can be inserted into the housing 12 through an aperture 86 at the front portion 14 of the housing 12 or an aperture 88 at the rear portion 16 of the housing 12, as shown in FIG. 9. The bar 18 can be of a generally rectangular shape, a circular shape, a square shape, or any combination thereof. A first jaw 24 is coupled to the front portion 14 of the housing 12, and a second jaw 26 is coupled to the first end 20 or the second end 22 of the bar 18, depending on whether the quick action clamp 10 is in the clamping or spreading configuration, respectively. Alternatively, the second jaw 26 may be designed with clamping faces on both sides of the jaw 26. In this configuration, to orientate the quick action clamp 10 into the spreading configuration, the second jaw 26 may remain fixed to the first end 20 of the bar 18, and the bar 18 may be orientated in the opposite direction, such that the second end 22 of the bar 18 is disposed first through the aperture 88 located within the rear portion 16 of the housing 12. A handle 28 is coupled to the rear portion 16 of the housing 12, where the handle 28 is intended to be gripped by a user. The handle 28 can be integral with the housing 12, or can be a separate component that is attached to the housing 12.

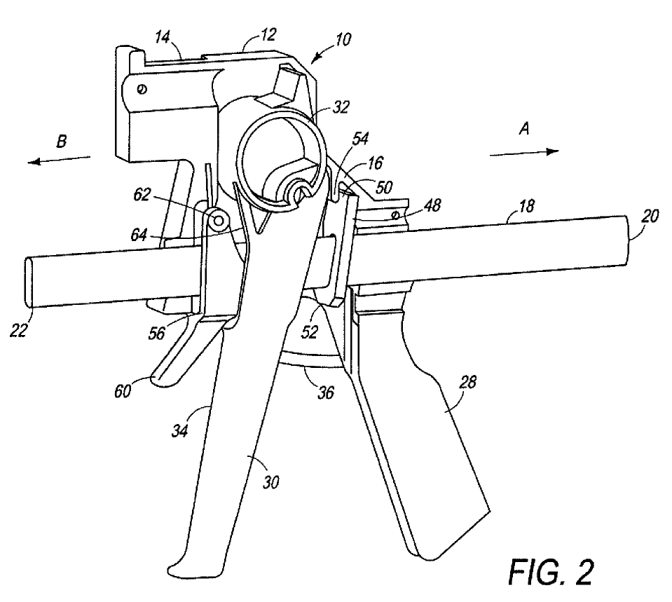

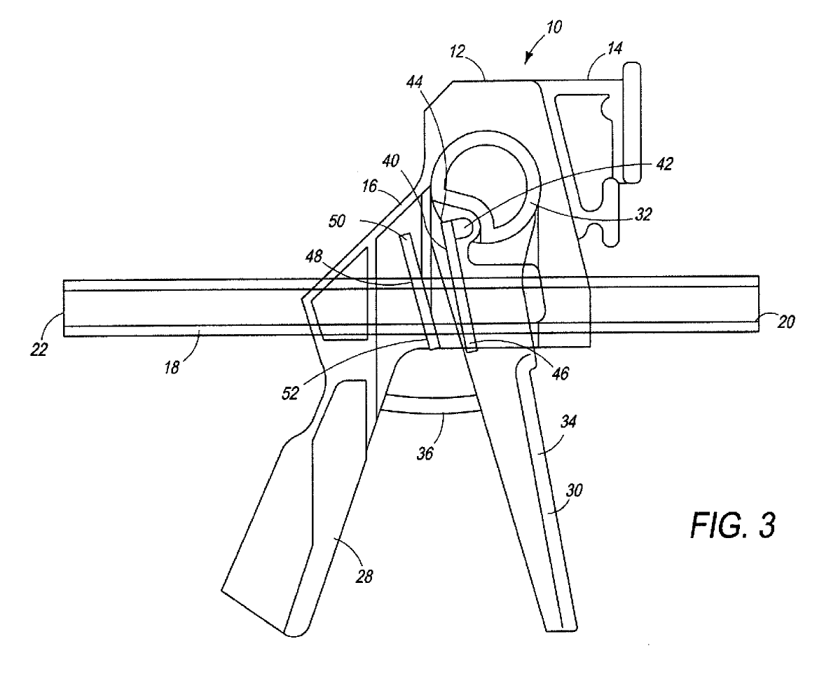

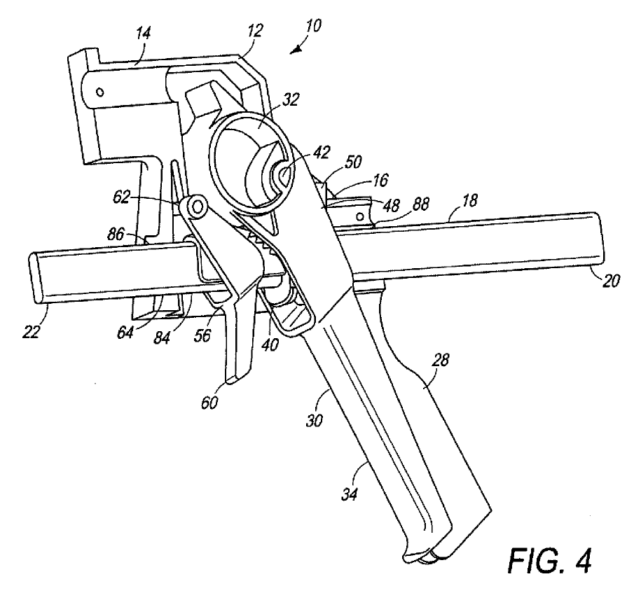

As better shown in FIGS. 2 and 3, a lever 30 is pivotally located within the housing 12. The lever 30 has a lever actuating position, as shown in FIG. 4, and a lever non-actuating position, as shown in FIG. 2. The lever 30 includes an eccentric portion 32 disposed within the housing 12, and an external portion 34 that is disposed outside of the housing 12. The eccentric portion 32 of the lever 30 rests within an inner portion of the housing 12, where, in a preferred embodiment, the eccentric portion 32 is not directly coupled with the inner portion of the housing 12, but rather is pivotally displaced between a track forming part of the housing 12 and is retained within the housing 12.

As shown in FIG. 3, a biasing member 36 is coupled to the lever 30 and the housing 12. The biasing member 36, in one embodiment, is a compression spring that may be disposed between the lever 30 and the handle portion 28 of the housing 12 that biases the lever 30 towards the lever non-actuating position, as shown in FIG. 3. It is contemplated that the biasing member 36 may also be disposed in other locations in the housing 12, such as above the bar 18, and can be in contact with other portions of the lever 30, so long as the function of the biasing member 36 is not impaired.

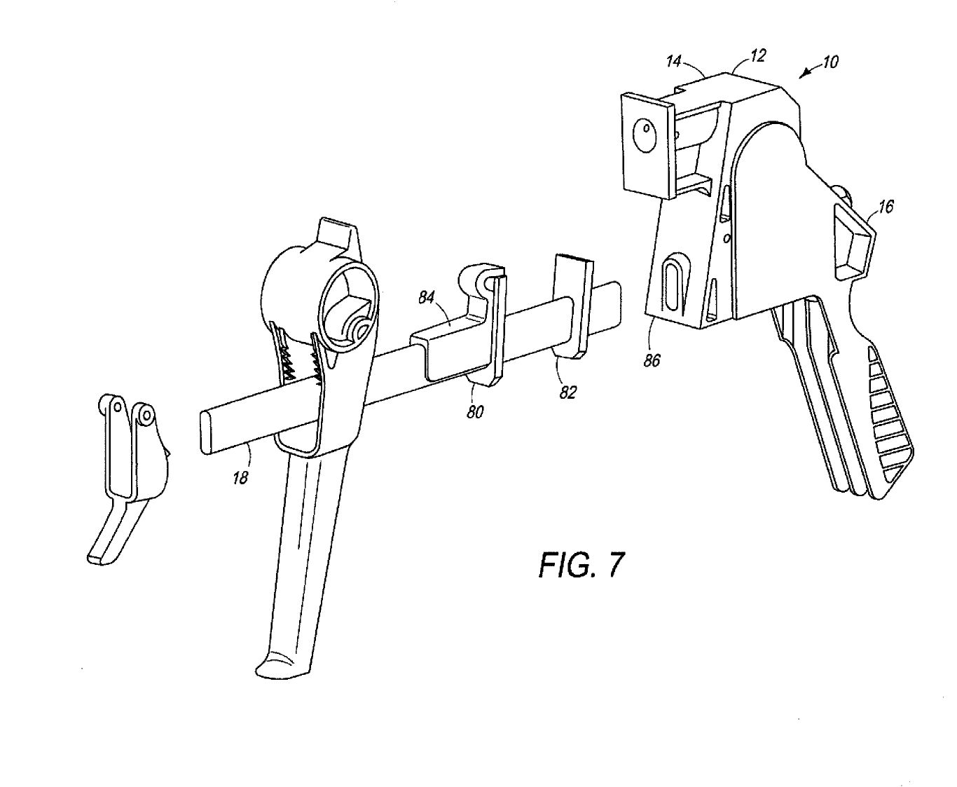

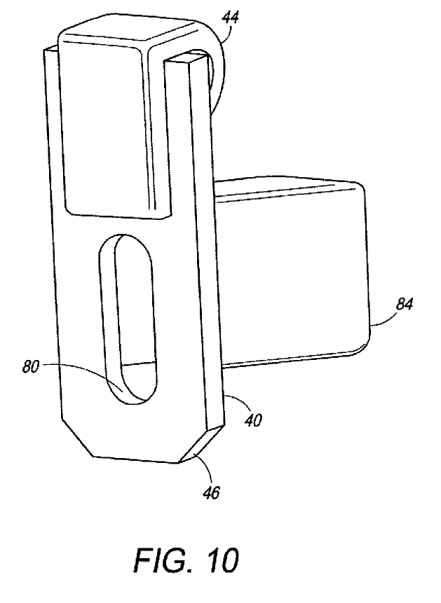

As illustrated in FIG. 3, a first jamb plate 40 is fixedly coupled with the lever 30, via a pin 42. The first jamb plate 40 can be of a generally rectangular shape with an aperture 80 formed therein, as shown in FIGS. 8 and 10. The first jamb plate 40, has a first jamb plate engaging position, as shown in FIG. 4, and a first jamb plate non-engaging position, as shown in FIG. 3. The first jamb plate 40 includes a top portion 44 that may be bent or shaped in such a fashion to fixedly couple with the lever 30, and a bottom portion 46. Depending on the shape of the top portion 44 of the first jamb plate 40, it may not be necessary to employ the use of the pin 42 to couple the first jamb plate 40 to the eccentric portion 32 of lever 30. For example, the top portion 44 of the first jamb plate 40 may be molded into the eccentric portion 32 of the lever 30. Regardless of how the first jamb plate 40 is fixedly coupled with the eccentric portion 32 of the lever 30, the force produced by the rotation of the lever 30 is translated to the first jamb plate 40 though the eccentric portion 32. Accordingly, the axial force produced by the first jamb plate 40 and the bar 18 is also translated to the eccentric portion 32 of the lever 30, and is substantially at the same vertical location as the first jaw 24 and the second jaw 26 are, and is where the clamping/spreading force is required.

The first jamb plate 40, as shown in FIGS. 8 and 10, may also be coupled to an alignment sleeve 84. The alignment sleeve 84 prevents the housing 12 from moving in a non-linear direction, which may be caused by the operation of the quick action clamp 10. The alignment sleeve 84, however, is not a necessary element.

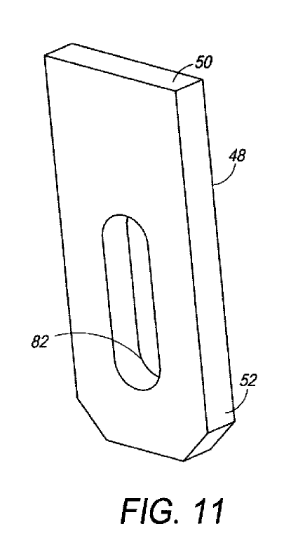

Referring back to FIG. 2, a second jamb plate 48 is also disposed in the housing 12. The second jamb plate 48 can also be of a generally rectangular shape with an aperture 82 formed therein, as shown in FIG. 11. However, it is contemplated that the second jamb plate 48 can be of any other suitable shape, such as, a square shape or an oval shape. The second jamb plate 48 has a second jamb plate non-release position, as shown in FIG. 2, and a second jamb plate release position. As shown in FIG. 2, the second jamb plate 48 is disposed in the rear portion 16 of the housing 12, and also has a top portion 50 and a bottom portion 52. The top portion 50 of the second jamb plate 48 is designed to pivot about a ridge 54 disposed in the rear portion 16 of the housing 12. As illustrated in FIG. 2, the top portion 50 of the second jamb plate 48 is wedged against a portion of the bar 18. The location of the second jamb plate 48 within the housing 12 may vary, and for example, may be disposed in the front portion 14 of the housing 12.

As shown in FIGS. 2 and 3, the bar 18 is disposed through the first jamb plate 40 and the second jamb plate 48, however, the design of either jamb plate 40, 48 may vary, and will serve their desired purpose so long as a portion of both the jamb plates 40, 48 comes in contact with the bar 18 as described below.

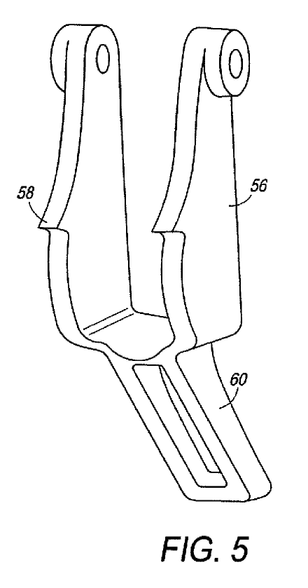

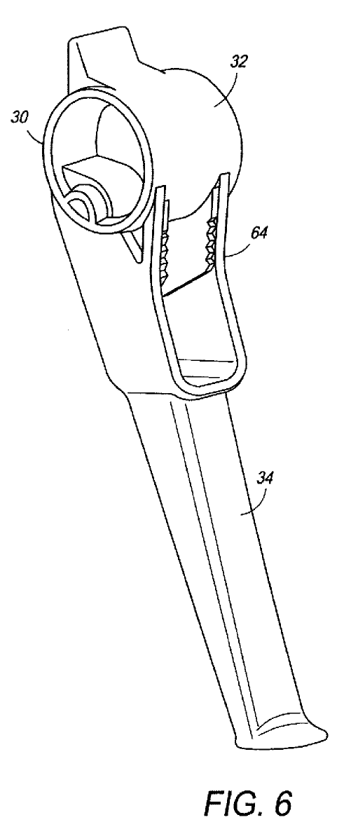

As shown in FIGS. 4 and 5, a detent member 56 is pivotally coupled with the front portion 14 of the housing 12. The detent member 56 has a detent unlock position, as shown in FIG. 2, and a detent lock position, as shown in FIG. 4. The detent member 56 comprises a detent portion 58 and a trigger portion 60. A biasing member 62, such as a torsion spring, is disposed within the housing 12, is engaged with the detent member 56, and biases the detent member 56 towards the detent unlock position. As illustrated in FIGS. 4 and 6, the lever 30 has a series of notches 64, each of which are configured to engage with the detent portion 58 of the detent member 56, to lock the lever 30 in a desired orientation. The detent member 56, as well as the lever 30, may also be located on one side of the bar 18, instead of being disposed on both sides of the bar 18 as shown in FIG. 4.

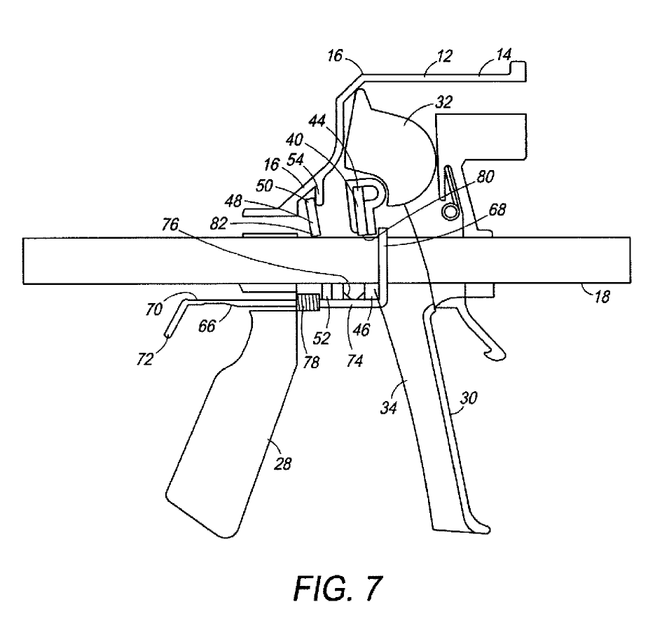

As illustrated in FIG. 7, in one embodiment, a jamb plate release actuator 66 is partially, and slidingly, disposed within the housing 12. The jamb plate release actuator 66 has a non-release position, as shown in FIG. 7, and a release position. The jamb plate release actuator 66 includes a first end 68 and a second end 70. The first end 68 of the jamb plate release actuator 66 is slidingly disposed about the bar 18, and is adjacent to the first jamb plate 40. The second end 70 of the jamb plate release actuator 66 includes a handle portion 72 that is disposed adjacent to the handle 28 of the housing 12. The jamb plate release actuator 66 further includes a first projection 74 disposed adjacent to the first jamb plate 40 and a second projection 76 disposed adjacent to the second jamb plate 48. The first and second projections 74, 76, may take on a variety of shapes, such as, without limitation, a wedge shape, a square shape, or a rectangular shape. A biasing member 78 is disposed about the jamb plate release actuator 66 and is configured to bias the jamb plate release actuator 66 towards the non-release position. In this embodiment, the biasing member 78 is shown as a coil spring.

The quick action clamp 10 may either be used to clamp two or more workpieces together, or be used to as a spreader to separate two or more workpieces away from one another. However, the method of operation is substantially the same for either function, and therefore both functions will be discussed in unison.

In operation, the biasing member 36 biases the lever 30 in the non-actuating position, as shown in FIG. 3, by exerting a force on the lever 30. As the lever 30 is squeezed against the biasing force, the lever 30 is actuated from the lever non-actuating position, as shown in FIG. 1, towards the lever actuating position, as shown in FIG. 4. When in the lever actuating position, the lever 30 is adjacent to the handle 28 of the housing 12. The pivoting of the lever 30 causes the first jamb plate 40 to simultaneously move from the first jamb plate non-engaging position, as shown in FIG. 3, where the first jamb plate 40 is not mechanically engaged with or fixed with respect to the bar 18, to the first jamb plate engaging position, where the top portion 44 of the first jamb plate 40 is bound against the bar 18, thereby locking the first jamb plate 40 and the lever 30 with the bar 18. This orientation enables the entire housing 12 to travel along the bar 18 and towards the second end 22 of the bar 18. It is important to note that the first jamb plate 40 is in the first jamb plate non-engaging position when the lever 30 is orientated in the lever non-actuating position. When the lever 30 is positioned towards the lever actuating position, the first jamb plate 40 is bound against the bar 18, and is in the first jamb plate engaging position.

Once the lever 30 is released, the biasing member 36 biases the lever 30 towards the lever non-actuating position, as shown in FIG. 2. As the lever 30 is biased towards the lever non-actuating position, the top portion 44 of the first jamb plate 40 disengages from the bar 18 and returns to the first jamb plate non-engaging position. The lever 30 may again be actuated from its non-actuating position towards the lever actuating position to further displace the housing 12 towards the second end 22 of the bar 18.

When the lever 30 is actuated between the lever actuating position and the lever non-actuating position, and anywhere in between, the second jamb plate 48 remains in the non-release position, as shown in FIG. 2. In the non-release position, a top portion 50 of the second jamb plate 48 is wedged against the bar 18 in a configuration to prevent the housing 12 from moving towards the first end 20 of the bar 18, as indicated by the arrow A, but freely allows the housing 12 to move towards the second end 22 of the bar 18, as indicated by the arrow B. In one embodiment, to release the housing 12 from the bar 18, and to allow the housing 12 to freely travel towards the first end 20 of the bar 18 as indicated by the arrow A, the second jamb plate 48 can be manually biased towards the release position by disengaging the top portion 50 of the second jamb plate 48 from the bar 18.

It can be appreciated that if the second jaw 26, as shown in FIG. 1 is disposed on the second end 22 of the bar 18, the displacement of the housing 12 towards the second end 22 of the bar 18 would cause the first and second jaws 24, 26 to converge towards one another, and allow for the clamping of two or more workpieces. Alternatively, if the second jaw 26 is located on the first end 20 of the bar 18, the displacement of the housing 12 towards the second end 22 of the bar 18, would cause the first and second jaws 24, 26 to diverge from one another, to separate two or more workpieces away from one another.

In an another embodiment the second jaw 26 has a first and a second clamping face, therefore it is not necessary to move the second jaw 26 from the first end 20 to the second end 22 of the bar 18. Instead, the bar 18 is reoriented, by inserting the first end 20 of the bar 18 first through the aperture 88 located at the rear portion 16 of the housing 12.

In yet another embodiment, a third jaw is disposed on the second end 22 of the bar 18. In this orientation, it would unnecessary to switch the orientation of the bar 18 or the second jaw 26. Instead, the quick action clamp 10 may be repositioned to incorporate the use of the first jaw 24 and the third jaw.

The jamb plate release actuator 66 is at least partially disposed within the housing 12, and is in the non-release position as shown in FIG. 7. In the non-release position, the first end 68 of the jamb plate release actuator 66 is adjacent to, and biasing, the first jamb plate 40 towards its engaging position, thereby reducing the time between the actuation of the lever 30 from the lever non-actuating position and when the first jamb plate 40 wedges against the bar 18. To actuate the second jamb plate 48 to its release position, and thereby allowing the housing 12 to freely travel towards the first end 20 of the bar 18, the second end 70 of the jamb plate release actuator 66 is retracted away from the housing 12, and from its non-release position, as shown in FIG. 7. This in turn causes the first and second projections 74, 76 to move towards the handle portion 28 of the housing 12. The first end 68 of the jamb plate release actuator 66 biases the first jamb plate 40 towards the first jamb plate non-engaging position. The second projection 76 biases the second jamb plate 48 from the second jamb plate non-release position, as shown in FIG. 7, to the second jamb plate release position, thereby allowing the housing 12 to freely travel in either direction along the bar 18. In this orientation, the jamb plate release actuator 66 is in the release position. Once the handle 72 of the jamb plate release actuator 66 is released, the biasing member 78, which is disposed within the housing 12 and about the jamb plate release actuator 66, biases the jamb plate release actuator 66 from the release position back to the original non-release position, as shown in FIG. 7.

In an alternative embodiment, to prevent the loss of clamp pressure, the lever 30 can be locked in the lever actuating position. To lock the lever 30 the detent member 56 is pivoted from the unlock position, as shown in FIG. 2, towards the lock position, as shown in FIG. 4, via the trigger portion 60. The detent portion 58 is configured to engage one of the notches 64 disposed within the lever 30, thereby locking the lever 30 in position as illustrated in FIG. 4. In this orientation, the first jamb plate 40 is still wedged against the bar 18 in the jamb plate engaging position.

To disengage the detent member 56 from the lever 30, the lever 30 is pivoted towards the lever actuating position and the detent portion 58 automatically disengages one of the notches 64 disposed within the lever 30. The biasing member 62 then biases the detent member 56 back to the unlock position. It can also be appreciated that it may not be necessary to pivot the lever 30 towards the lever actuating position to release the detent member 56, and instead the return of the detent member 56 to the unlock position may be accomplished by rotating the trigger portion 60 towards the unlock position, thereby releasing the detent portion 58 from one of the notches 64 of the lever 30.

While the invention has been illustrated and described in detail in the drawings and foregoing description, the same is to be considered as illustrative and not restrictive in character, it being understood that only exemplary embodiments have been shown and described and do not limit the scope of the invention in any manner. It can be appreciated that any of the features described herein may be used with any embodiment. The illustrative embodiments are not exclusive of each other or of other embodiments not recited herein. Accordingly, the invention also provides embodiments that comprise combinations of one or more of the illustrative embodiments described above. Modifications and variations of the invention as herein set forth can be made without departing from the spirit and scope thereof, and, therefore, only such limitations should be imposed as are indicated by the appended claims.

We claim:

1. A quick action clamp, comprising:
a housing having a front portion and a rear portion;
a first jaw coupled to the front portion of the housing;
a bar, having a first end and a second end, where the housing is movably disposed on a portion of the bar;
a second jaw coupled to one end of the bar;
a handle portion forming part of the rear portion of the housing;
a lever mounted within, and extending from, the housing having an eccentric portion disposed above the bar;
a first jamb plate fixedly coupled with the eccentric portion of the lever, where the bar is disposed through the first jamb plate.

2. The quick action clamp of claim 1, wherein the lever has a lever non-actuating position and a lever actuating position, where pivoting the lever from the lever non-actuating position towards the lever actuating position causes the first jamb plate to move from a first jamb plate non-engaging position to a first jamb plate engaging position, where when in the first jamb plate engaging position, the jamb plate is wedged against the bar, and displaces the housing in a first direction, and where releasing the lever from the lever actuating position towards the lever non-actuating position causes the first jamb plate to move from the first jamb plate engaging position to the first jamb plate non-engaging position.

3. The quick action clamp of claim 1, further comprising a second jamb plate pivotally disposed within the housing and about the bar, and in a second jamb plate non-release position when the second jamb plate is wedged against the bar and prevents the housing from traveling in a second direction, which is opposite from the first direction.

4. The quick action clamp of claim 2, further comprising a biasing member coupled to the housing and the lever, where the biasing member biases the lever towards the lever non-actuating position.

5. The quick action clamp of claim 4 wherein as the lever is pivoted from the lever non-actuating position towards the lever actuating position, the first jaw converges towards the second jaw.

6. The quick action clamp of claim 4 wherein as the lever is pivoted from the lever non-actuating position towards the lever actuating position, the first jaw diverges away from the second jaw.

7. The quick action clamp of claim 3, further comprising a jamb plate release actuator at least partially located within the housing.

8. The quick action clamp of claim 7, wherein the jamb plate release actuator further comprises a first end and a second end, where the first end is disposed about the rod, and the second end is adjacent to, and extends from, the second portion of the housing.

9. The quick action clamp of claim 8, wherein the jamb plate release actuator further comprises a first projection, where the jamb plate release actuator has a non-release position and a release position, where when in the non-release position, the first projection is adjacent to the first jamb plate and biases the first jamb plate towards the engaging position.

10. The quick action clamp of claim 9, wherein the jamb plate release actuator further comprises a second projection, where when in the release position, the second projection biases the second jamb plate to the non-engaging position, thereby releasing the housing from the rod, and allowing the housing to freely travel in the first or second directions.

11. The quick action clamp of claim 10, further comprising a biasing member disposed about the jamb plate release actuator, where the biasing member biases the jamb plate release actuator towards the non-release position.

12. The quick action clamp of claim 1, further comprising a detent member pivotally coupled with the first portion of the housing, having a detent unlock position and a detent lock position.

13. The quick action clamp of claim 12, wherein the lever further comprises at least one notch, the at least one notch configured to engage with the detent of the detent member when the detent member is actuated towards the detent lock position.

14. The quick action clamp of claim 13, further comprising a biasing member in communication with the detent member and the housing, which biases the detent member towards the detent unlock position.

15. A quick action clamp, comprising:
a housing having a front portion and a rear portion;
a first jaw coupled to the front portion of the housing;
a bar, having a first end and a second end, where the housing is movably disposed on a portion of the bar, where the housing can move in a first direction or a second direction with respect to the bar;
a second jaw coupled to one end the bar, where as the housing moves in the first direction the first jaw converges towards the second jaw, and as the housing moves in the second direction the first jaw diverges from the second jaw;
a handle coupled with the rear portion of the housing;
a lever pivotally mounted to, and extending from, the housing having a lever non-actuating position and a lever actuating position, the lever having an eccentric portion disposed in the housing above the bar;
a first jamb plate coupled with the eccentric portion of the lever having a first jamb plate engaging position and a first jamb plate non-engaging position; and
a second jamb plate disposed in the housing, where the bar is disposed through the first jamb plate and the second jamb plate, wherein the second jamb plate has a second jamb plate non-release position and a second jamb plate release position;
wherein the lever is in the non-actuating position, the first jamb plate is in the first jamb plate non-engaging position and the second jamb plate is in the second jamb plate non-release position, and when the lever is actuated towards the lever actuating position, the first jamb plate is in the first jamb plate engaging position and displaces the housing in a first direction, and the second jamb plate is still in the non-release position, which prevents the housing to move in a direction opposite from the first direction.

16. The quick action clamp of claim 15 further comprises a jamb plate release actuator movably disposed within the housing having a first end and a second end, where the first end is disposed about the bar, and the second end is adjacent to, and at least partially extends from, the second portion of the housing.

17. The quick action clamp of claim 16 wherein the jamb plate release actuator further comprises a first projection, and a second projection, where the jamb plate release actuator has a non-release position and a release position, where when in the non-release position, the first projection is adjacent to the first jamb plate and biases the first jamb plate towards the first jamb plate engaging position, and when in the release position, the second projection plate biases the second jamb plate towards a release position, thereby releasing the housing from the bar, and allowing the housing to freely travel in the first or second directions.

18. The quick action clamp of claim 15, further comprising a detent member pivotally coupled with the first portion of the housing, having a detent unlock position and a detent lock position.

19. The quick action clamp of claim 18, wherein the lever further comprises at last one notch configured to engage with the detent of the detent member when the detent member is in the detent lock position.

20. The quick action clamp of claim 18, further comprising a biasing member disposed adjacent to the detent member, which biases the detent member towards the detent unlock position.

21. A quick action clamp, comprising:
a housing having a front portion and a rear portion;
a bar, having a first end and a second end, where the housing is movably disposed on a portion of the bar and, where the housing can move in a first direction or a second direction with respect to the bar;
a handle portion forming part of the rear portion of the housing;
a lever disposed within, and extending from, the housing having a lever actuating position and a lever non-actuating position, the lever having an eccentric portion disposed above the bar;
a first jamb plate fixedly coupled with the eccentric portion of the lever having a first jamb plate engaging position, where the first jamb plate is fixedly engaged with the bar in the first direction, and a first jamb plate non-engaging position, where the first jamb plate is disengaged from the bar in the first direction;
a second jamb plate disposed in the housing having a second jamb plate non-release position, where the second jamb plate is fixedly engaged with the bar in the second direction, and a second jamb plate release position, where the second jamb plate is not fixedly engaged with the bar in the first or second direction; and
a jamb plate release actuator slidingly disposed in the housing having a release position and a non-release position, further comprising:
a first upward projection adjacent to the first jamb plate;
a second upward projection adjacent to the second jamb plate;
such that when the jamb plate release actuator is in the non-release position, the first projection is adjacent to the first jamb plate, and when in the release position, the second projection positions the second jamb plate in the second jamb plate release position.

22. The quick action clamp of claim 21, further comprising a detent member pivotally coupled with the first portion of the housing, having a detent unlock position and a detent lock position.

23. The quick action clamp of claim 22, further comprising a biasing member disposed adjacent to the detent member and the housing.

24. The quick action clamp of claim 23, wherein the lever further comprises at least one notch, the at least one notch is configured to engage with the detent member when the detent member is in the detent lock position.
